(19) United States
(12) Patent Application Publication
(10) Pub. No.: US 2004/0234496 A1
(43) Pub. Date: Nov. 25, 2004

(54) Biocidal compositions

(76) Inventor: Richard F. Stockel, Bridgewater, NJ (US)

Correspondence Address: RICHARD F. STOCKEL, 475 ROLLING HILLS ROAD, BRIDGEWATER, NJ, 08807, US

(21) Appl. No.: 10/770,248

(22) Filed: Feb. 2, 2004

Related U.S. Application Data
(60) Provisional application No. 60/445,104, filed on Feb. 6, 2003.

(51) Int. Cl. A01N 61/00

(52) U.S. Cl. 424/78.27

(57) ABSTRACT

Biocidal compositions formed by metathesis of either monomeric or polymeric bioactive cations with either monomeric or polymeric bioactive anions to from an essentially water insoluble complexes.

Some of these complexes can also be synthesized by a acid-base reaction whereby the acid molecule is capable of donating a proton, to the free base molecule resulting in the formation of the desired complex.

These novel and unique compounds or polymers are effective against a wide variety of microbial species.

### INVENTION

This invention relates to new biocidal complexes prepared by metathesis synthesis involving either a monomeric or polymeric cationic biocide reacted with the anionic form of a biocide of a monomeric or polymeric biocide. These complexes tend to have low water solubility therefore for many, but not all applications it is necessary to prepare emulsions or microemulsions to obtain a stable aqueous solution.

The formation of all the complexes of this invention can be synthesized by metathesis reactions carried out in aqueous solutions, or aqueous alcohol mixtures. These bioactive complexes are produced using a environmental approach (green chemistry). Water is the solvent of choice, by-products are harmless salts and yields are excellent.

Some of the same bioactive complexes of this invention can also be synthesized by a straight forward acid-base reaction. This involves the direct combination of a free base bioactive molecule containing at least one or more nitrogen atom having a pair of electrons with a bioactive molecule capable of donating a proton to from the complexes of this invention. This synthetic route is particularly useful, when preparing complexes of anti-fungal and antibacterial compounds known as azoles and certain antibiotics having the ability of being protonated respectively. The following reaction serves as a illustration.

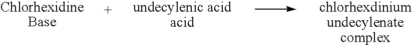

In order for the acid-base process to work the bioactive acid component must have a transferable proton to a basic bioactive nitrogen compound having a lone pair of electrons. The reaction is usually conducted in refluxing alcohol (C₁-C₄), or aqueous alcoholic solutions.

These complexes are very effective biocides against a variety of bacteria, fung, protozoa, helminthes and viruses.

### BACKGROUND OF THE INVENTION

Individually, the biocides of this invention are well known in the published literature, however the complexes of this invention are quite unique, novel and represent new biocidal compositions.

In accordance with this invention, the effectiveness of individual biologically active compounds can be enhanced by the formation of these complexes as described by this invention. Thus the combination of a bioactive cation with a bioactive anion improves the overall biological activity.

This invention has other important safety and toxicity implications because the resulting complex can be composed of either EPA or FDA approved materials.

Another advantage involves the green chemistry used in synthesizing these compositions. Fortunately, the metathesis reaction can be carried out in a totally aqueous medium. The by-product of this reaction is a salt, which does not represent any serious environmental problem for disposal. In fact, many salts can be recycled for other uses.

While the literature is replete with many patents and articles concerning the individual components of this invention, there is scarce mention of preparing the complexes of this invention. For example, WO 97/25085 describes the combination (admixture) of chlorhexidine with triclosan to contribute antimicrobial activity when applied to medical devices and the like. The inventors do not anticipate our technology, because no mention is made about a chemical reaction between these two biocides, nor does the method they use to apply these biocides allow the formation of a complex.

U.S. Pat. No. 5,575,993 discloses compositions of polyionenes with anionic biological species. However, my invention is not anticipated by 993′, since the two are significantly different from each other. These differences are clearly delineated in 993′ whereby only part of the polyionene anion is replaced by a bioactive species, from about 0.005 to about 0.33 or 0.50 degree of substitution depending on the specific polyionene used. All of the resulting compositions are very soluble in water, unlike the compositions of my invention, prior to solubilization with the assistance of surfactants and cosolvents.

The invention will be illustrated by the following examples, which, it will be understood, are not intended to be limiting, but merely illustrative.

List of Bioactive Cationic Agents

The following monomeric and polymeric bioactive cationic agents are illustrative of this invention. They by no means represent all possible cationic biocides, but instead are examples of the broad array available to a practitioner who wishes to carry out the scope of this invention.

Examples:

Polyhexamethylene biguanide hydrochloride salt

Polyhexamethylene guanidine hydrochloride salt

Dimethyldidecyl ammonium chloride

Benzalkonium chloride

Bemzethonium chloride

Chlorhexidine digluconate

Poly(dimethyl butenyl ammonium chloride)alpha, omega-bis(triethanol-ammonium chloride

Propamidine

Dibromopropamidine

Poly(oxyethylene(dimethylimino)ethylene(dimethylimino)ethylene dichloride

Dequalinium chloride

Polyquaternium 2

Hexetidine

Cetyl pyridinium chloride

Tetrakis(hydroxy methyl)phosphonium sulfate

Gemini quats, e.g., ethanediyl-α,w-bis(dodecyldimethyl)ammonium halide

Quaternary ammonium dendrimeric biocides (U.S. Pat. No. 6,440,405)

Long chain sulfonium salts

Long chain phosphonium salts

Antibiotics containing at least one amine salt or more e.g., tetracycline, doxycycline, minocycline and the like

Azoles (are either triazoles or imidazoles), e.g., cyproconazole, fenbuconazole, tebuconazole, penconazole, tetraconazole are some examples

It is understood that these cationic antimicrobial agents can be other salts besides the hydrochloride. Some examples are hydroxy carboxylic acids, amino acids, sulfonates, and phosphates to name just a few examples. One skilled in organic chemistry could find other suitable substitutes.

The specific biocides described are illustrative of this invention, but do not represent a complete inventory of all the possible combinations possible. Anyone skilled in the art of chemistry and biology can conceptualize other modifications. In particular, some of the polymeric species useful for carrying out this invention could be further modified by varying the repeating units or by end capping. U.S. Pat. Nos. 4,891,423 and 5,741,886 are examples of further enhancing the antimicrobial activities of phmb. Other such examples for different polymeric systems also exit.

List of Specific Bioactive Anionic Agents

The following monomeric and polymeric bioactive anions represent a partial list of actives, which can be utilized in this invention. Knowledgeable persons familiar with biocides can conjure other possible anionic substitutes. In keeping with the spirit this of this invention, the list below is illustrative as working examples to achieve very broad antimicrobial activity for a variety of applications.

Sodium hydroxymethyl glycinate

Sodium tetrathiocarbonate

Sodium tribromosalicylanilide

Sodium tribromophenol

Sodium 2-bromo-4-hydroxy acetophenone

Disodium cyanodithioimidocarbamate

Potassium N-hydroxymethyl dithiocarbamate

Sodium allyl paraben

Sodium salicylanilide

Disodium bithional

Sodium trichloroacetate

Sodium stearate

Sodium mercaptobenozthiazole

Sodium dithiodimethyl carbamate

Sodium undecylenic acid

Sodium ortho-phenylphenol

Dissodium hexachlorophene

Sodium triclosan

Sodium 2,6-di-t-butyl, 4-methyl phenol

Sodium tetraborate

Poly anionic compositions like polydivinyl ether-maleic anhydride alternating copolymer

Anionic dendrimers (U.S. Pat. No. 6,464,971)

Chitosan derivatives having carboxylate, sulfate, sulfonate, phosphonate or phosphate anions

EDTA and derivatives having carboxylate anions

1-hydroxy ethane-1,1-diphosponic acid

nitrilotris (methylenephosphonic acid)

ethylenediaminetetrakis (methylene-phosphonic acid)

mono or di alkyl phosphates or mixtures thereof.

Surfactants

Experimentally, it has been determined that the preferred surfactants, which form microemulsions or emulsions with the compositions of this invention, are by and large, either of the amphoteric and non-ionic type, or combinations thereof. Highly charged anionic surfactants have the potential to reduce the overall bioactivity of these complexes by causing some degree of precipitation, thereby lessening its effective.

It was also found that certain cationic surfactants, sometimes in combination with non-ionic and/or amphoteric surfactants are effective in forming stable emulsions and/or microemulsions.

Surfactants that carry a positive charge in strongly acidic media, carry a negative charge in strongly basic media, and form zwitterionic species at intermediate pH's are amphoteric. The preferred pH range for the stability and effectiveness is from about 5.0 to about 9.0. Under this pH range the amphoteric surfactant is mostly or fully in the zwitter (overall neutral charge) form, thereby negating any dilution of bioactivity of the compositions of this invention.

There are several classes of amphoteric surfactants useful for preparing microemulsions or emulsions for the complexes of this invention. These are:

1. N-alkylamino acids

2. alkyldimethyl betaines

3. alkylamino betaines

4. sulfobetaines

5. imidazolines

6. amino or imino propionates

Some of the above amphoteric surfactants have moderate to good antimicrobial activity against certain microorganisms, and hence can be synergistic.

Nonionic surfactants have also been found to be useful to form small particle micelles for these complexes. These can be classified as the following:

1. alcohols

2. alkanolamides

a. alkanolamides

b. ethoxylated(propoxylated)amides

3. Amine oxides

4. Esters

a. ethoxylated(propoxylated)carboxylic acids

b. ethoxylated(propoxylated)glycerides

c. glycol esters (and derivatives)

d. mono(di)glycerides

e. polyglycerol esters

f. polyhydric alcohol esters and ethers

g. sorbitan/sorbital esters

h. di(tri)esters of phosphoric acid.

5. Ethers

a. ethoxylated(propoxylated)alcohols

b. ethoxylated(propoxylated)lanolin

c. ethoxylated(propoxylated)polysiloxanes

d. ethoxylated-propoxylated block copolymers

Two suitable cationic surfactants include D,L-2-pyrrolidone-5-carboxylic acid salt of ethyl-N-cocoyl-L-arginate (CAE), marketed by Ajinomto and cocamidopropyl, cocamidopropyl PG dimonium chloride phosphate (PTC), marketed by Uniqema, and the like.

It has been observed that the choice of a effective surfactant system will differ to some degree for each biocidal complex. The choice will depend on the surfactants hydrophilic-lipophilic balance (HLB) to form a stable small particle micelle in an aqueous or aqueous cosolvent medium solution. Also the combination of two or more amphoteric or a amphoteric-nonionic system or two or more nonionic surfactants can also be utilized to achieve satisfactory results.

It has been found that effective concentrations (based on the weight of the complex) of surfactants are in the range of 0.4 weight percent to about 6.0 weight percent.

Solvents

Since are complexes are mostly slightly soluble or insoluble in water, an appropriate solvent is required to solublize the biocidal composition in order to form an emulsion, or a microemulsion. The latter usually needs a cosolvent.

The choice of a solvent to effectively dissolve the complex is dependent on at least two criteria for the purposes of this invention.

In the concentrate form before dilution with additional water for a specific application, it is highly desirable that the concentration of water is about or greater than 70 weight percent of the total solvents present. It is also preferable to have at least 15 weight percent or greater of actives present in the concentrate.

In order to accomplish these minimum levels of solvents and actives, it is incumbent to choose the proper solvents. This can be done by determining the solubility parameter of the complex.

Experimentally, it has been found that when the complex has considerable ionic character and only slightly soluble in water, than alcohols (C₁-C₄), glycols, glycol ethers, glycol esters, di, tri and poly hydroxylic solvents can be utilized.

When the complex has a predominance of covalent bonding, then it may be necessary to use aprotic dipolar solvents in part, or in toto. Examples of these types of solvents (not all inclusive) are dimethyl formamide, dimethyl sulfoxide, N-methylpyrrolidone, morpholine N-oxide, or dimethyl-2-piperidone and the like. Other useful solvents found are mono/di/tri phosphates or mixtures thereof.

In certain cases whereby the complex has considerable hydrophobic functionality e.g., stearates it may be necessary to use aromatic solvents like toluene or xylene in part or in toto.

Sometimes, it was found necessary to use combinations of the above solvents to achieve stable emulsions or microemulsions for the biocidal complexes of this invention. In the final analysis, the total amounts of any of the solvents should be kept to a minimum. About 30 weight percent of the concentrate represents the upper limit. With 15 weight percent or less being preferred. These percentages are based only on the total weight of all the solvents present in the concentrate including water. A second criteria for the selection of a water-solvent system for these complexes is dependent on the specific application. If the intended use is for human or animal applications then the solvents should have a safe toxicity/irritation profile.

If the end-use is an industrial application, then the choice of solvents is much broader, but still should be relatively safe.

General Synthesis for the Formation of the Complexes of this Invention

The formation of all the candidate molecules are synthesized by straight forward metathesis reactions carried out in aqueous solutions.

These bioactive molecules are produced using the ultimate green chemistry approach. Water is the solvent of choice, by-products are harmless salts and yields are excellent to quantitative.

The appropriate cationic moiety is reacted with the desired anionic moiety in water. The concentration of reactants can vary from 20 to about 60 wt. % of the total solution. The reaction takes place at room temperature, and is generally completed within one hour.

The final product is readily removed by decantation, dried in an oven, and generally can be used as is for certain applications.

General Method for the Formation of Emulsions/Microemulsions for the Complexes of this Invention

The complex is dissolved in the minimum amount of a solvent with the appropriate Hildebrand solubility parameter. The solubility parameter is a numerical value that indicates the relative solvency behavior of a specific solvent. Hildebrand solubility parameters from about 8.5 to about 22.0 are suitable for solubilization of the complexes of this invention.

Depending on the ionic/covalent bonding energies of these compositions, the correct solvent for solubilization will be on the low side, if the bonding has more covalency, and if the bonding is more ionic, then the proper solvent will have a much higher value.

Combinations of solvents are also useful in preparing emulsions or microemulsions.

Next, an amphoteric or non-ionic is added to the dissolved complex. Combinations of the above type surfactants can also be utilized.

The complex-solvent-surfactant is then diluted with water to the active concentration required for the particular application to form an emulsion or microemulsion depending on the micellar size and choice of solvents/cosolvents.

### EXAMPLES

### Solubilization of Complexes Concentrates Dilatable with Water

| | | |
|---|---|---|
| 1. | phmb triclosante | 20 g active |
| | 11.02 wt. % | 150 g methanol |
| | solids | 10 g NMP |
| | 1.5 g Tego Betaine Z (real) | |
| 2. | chlorhexidinium di (diethyldithiocarbamate) | 15 g active |
| | 13.82 wt. % | 75 g ethanol |
| | solids | 15 g DMF |
| | | 3.5 g Tween 20 (real) |
| 3. | benzalkonium diethbyldithiocarbamate | 20 g active |
| | 18.43 wt. % | 80 g isopropanol |
| | solids | 5 g DMSO |
| | | 3.0 g Tween 20 (real) |
| 4. | chlorhexidinium di (2-mercaptobenzothiazole) | 20 g active |
| | 17.74 wt. % | 90 g NMP |
| | solid | 2.75 g Tego Betaine Z (real) |
| 5. | didecyldimethyl ammonium 2-mercapto-benzothiazole | 20 g active |
| | 19.41 wt. % | 65 g isopropanol |
| | solids | 15 g DMF |
| | | 3.0 g Tego Betaine (real) |
| 6. | chlorhexidinium di(2-mercapto-pyridine N-oxides) | 20 g active |
| | 22.22 wt. % | 60 g DMF |
| | solids | 10 g N-octyl NMP |
| 7. | phmb 2-mercapto-pyridine N-oxide | 25 g active |
| | 28.41 wt. % | 50 g NMP |
| | solids | 10 g isopropanol |
| | | 3 g phospholipid CDM (real) |
| 8. | Tetrakis (hydroxymethyl phosphonium 2- | 25 g active |
| | mercapto-pyridine N-oxide | |
| | 23.04 wt. % | 70 g isopropanol |
| | solids | 10 g DMSO |
| | | 3.5 g Tego Betaine Z (real) |
| 9. | Poly (oxyethylene (dimethyliminio) ethylene (dimethyl | 20 g active |
| | iminio) ethylene di(2-mercapto-pyridine N-oxide | |
| | 21.51 wt. % | 60 g isopropanol |
| | solids | 10 g NMP |
| | | 3.0 g Tego Betaine Z |
| 10. | chlorhexidinium di (triclosante) | 20 g active |
| | 20.20 wt. % | 70 g ethanol |
| | solids | 5 g DMF |
| | | 2 g each Tween 20/ |
| | | Tego Betaine Z (real) |
| 11. | chlorhexidinium di (stearate) | 20 g |
| | 16.39 wt. % | 25 g isopropanol |
| | solid | 75 g NMP |
| | | 2 g each of Tween 20 |
| | | and Tego Betaine Z (real) |
| 12. | di phmb ethylenediaminetetraacetic acid (diacetate) | 20 g |
| | | 30 g DMSO |
| | | 70 g isopropanol |
| | | 3.5 g Tego Betaine Z (real) |

Microbiological Tests

The bacteriostatic activity of several complexes was investigated by testing at 0.1 wt. % using Oxoid No. 2 nutrient broth and inoculating the broth with 1 ml of a 24 hour broth culture of the test organisms. After incubation at the optimum growth temperature of the organism for 48 hours.

The organisms tested were:

Staphylococcus aureous (gram positive)

Pseudomonas aeruginosa (gram negative)

Escherichia coli (gram negative)

Compounds 1,5,6,7,8,9 and 10 were tested and found to be bacteriostatic at 0.1 wt. % against the above 3 organisms. These complexes were the only one studied using this test.

1. Biocidal compositions prepared by a metathesis reaction of a water soluble monomeric or polymeric biocidal cationic molecule with a water soluble monomeric or polymeric biocidal anionic molecule.

2. A biocidal composition as described in claim 1 comprising a biguanide cation.

3. A biocidal composition as described in claim 2 wherein the biguanide cation is derived from chlorhexidine.

4. A biocidal composition as described in claim 2 wherein the biguanide cation is derived from polyhexamethylene biguanide.

5. A biocidal composition as described in claim 1 comprising a guanidine cation.

6. A biocidal composition as described in claim 5 wherein the guanidine cation is derived from 9-aza-1,17-diguanidoheptadecane.

7. A biocidal composition as described in claim 5 wherein the guanidine cation is derived from polyhexamethylene guanidine.

8. A composition as described in claim 1 comprising an amidine cation.

9. A biocidal composition as described in claim 8 wherein the amidine cation is derived from dibromopropamidine.

10. A composition as described in claim 1 comprising a polyionene cation.

11. A biocidal composition as described in claim 10 wherein the polyronene cation is poly(oxyethylene(dimethylimino)ethylene(dimethylimino)ethylene).

12. A composition as described in claim 1 comprising a biocidal quaternary cation.

13. A biocidal composition as described in claim 12 wherein the quaternary is didecyldimethyl ammonium cation.

14. A composition as described in claim 1 comprising a phosphonium cation.

15. A biocidal composition as described in claim 14 wherein the phosphonium cation is Tetrakis(hydroxymethyl)phosphonium cation.

16. A biocidal composition as described in claim 1 comprising a phenolate or substituted phenolate anion.

17. A biocidal composition as described in claim 16 wherein the phenolate anion is triclosan amion.

18. A biocidal composition as decribed in claim 16 wherein the phenolate anion is t-butyl hydroxy toluene.

19. A biocidal composition as described in claim 1 comprising a flavonoid anion.

20. A biocidal composition as described in claim 19 wherein the flavonoid anion is hesperlin.

21. A biocidal composition as described in claim 1 comprising a organomercaptan anion.

22. A biocidal composition as described in claim 21 wherein the organomercaption anion is 2-mercapto-pyridine N-oxide.

23. A biocidal composition as described in claim 2 comprising a dialkyl dithiocarbamate anion.

24. A biocidal composition as described in claim 23 wherein the dialkyl dithiocarbamate anion is dimethyl dithiocarbamate.

25. A biocidal composition as described in claim 1 comprising an enolizable hydrogen atom.

26. A biocidal composition as described in claim 25 wherein the enolizable hydrogen atom anion molecule is hinokitiol.

27. A biocidal composition as described in claim 1 comprising mono, di alkyl phosphate, or mixtures thereof.

28. A biocidal composition as described in claim 27 wherein the mono or di phosphate anion is ethyl hexyl phosphate.

29. A biocidal composition as described in claim 1 comprising a carboxylic anion.

30. A biocidal composition as described in claim 29 wherein the carboxylic anion is undecylenic acid.

31. A biocidal composition as described in claim 1 comprising an aminocarboxylic anion.

32. A biocidal composition as described in claim 31 wherein the aminocarboxylic acid anion is ethylenediamine tetra-acetic acid.

33. A biocidal composition as described in claim 1 comprising an aminophosphonate.

34. A biocidal composition as described in claim 33 wherein the aminophosphonate is ethylenediamine tetra (methylphosphonic acid).

35. The compositions of claim 1 solubilized in form of an emulsion by dissolving them in a solvent, which also contains a surfactant capable of forming a stable micellar solution by diluting with water.

36. The solublized compositions of claim 35 wherein the solvent is a lower alkyl alcohol from C₁ to C₄.

37. The solubilized composition of claim 35 wherein the solvent is a glycol.

38. The solubilized composition of claim 35 wherein the solvent is a glycol ether.

39. The solubilized composition of claim 35 wherein the solvent is a glycol ester.

40. The solubilized compositions of claim 35 wherein the solvent is a aprotic dipolar liguid.

41. The solublized compositions of claim 35 wherein the solvent is a aromatic liquid.

42. The solubilized compositions of claim 25 wherein the surfactant is a betaine derivative.

43. The solubilized compositions of claim 35 wherein the surfactant is cocamidopropyl betaine.

44. The solubilized compositions of claim 35 wherein the surfactant is a non-ionic surfactant.

45. The solubilized compositions of claim 35 wherein the surfactant is polyoxyethylene (20) monolaurate.

46. Biocidal compositions prepared by a acid-base reaction between a bioactive amine molecule having at least one nitrogen atom with a free pair of electrons capable of being protonated by a bioactive acid.

47. Biocidal compositions as defined in claim 46 wherein the base is an azole antifungal compound being capable of forming an amine acid functionality with a bioactive acid.

48. Biocidal compositions as defined in claim 47 wherein the azoles are cloconazole, clotrimazole, cyproconazole, fenbuconazole, myclobutanil, propiconazole, tebuconazole, tridimefon, and miconazole.

49. Biocidal compositions as defined in claim 46 wherein the base is a antibiotic compound being capable of forming an amine salt functionality with a bioactive acid.

50. Biocidal compositions as defined in claim 49 wherein the antibiotic consist of tetracycline, clindamycin, tazardtene, erythromycin, clinafloxacin, doxycycline, minocyctine or lincomycin.
